(19) United States
(12) Patent Application Publication
(10) Pub. No.: US 2026/0153138 A1
(43) Pub. Date: Jun. 4, 2026

(54) SYSTEMS AND METHODS FOR PARALLEL PATH VARIATORS

(71) Applicant: Caterpillar Inc., Peoria, IL (US)

(72) Inventors: Rodwan T. Adra, Peoria, IL (US); Todd Ryan Kabrich, Tomball, TX (US); Mark Francis Grimes, Cypress, TX (US); Riadh Benguedda, Cypress, TX (US); Miguel M. Cervantes, Houston, TX (US); John Martin Seipold, Peoria, IL (US)

(73) Assignee: Caterpillar Inc., Peoria, IL (US)

(21) Appl. No.: 18/964,185

(22) Filed: Nov. 29, 2024

(51) Int. Cl. F16H 3/72; F04B 35/04; F16H 3/00

(52) U.S. Cl. CPC F16H 3/727; F04B 35/04; F16H 3/006

(57) ABSTRACT

At least one aspect of the present disclosure is directed to systems and methods for providing variable drive speeds. A drive system can include a gearbox including a first gear driven by a first input shaft, a second gear driven by a second input shaft, and a third gear driven by the first gear and the second gear. The third gear can drive an output shaft (which can be operatively coupled to an external component, such as a compressor). The drive system can include a first motor configured to operate at a constant drive speed. The first motor can be operatively coupled to the first input shaft. The drive system can include a second motor configured to operate at a variable drive speed via a variable frequency drive. The second motor can be operatively coupled to the second input shaft.

### TECHNICAL FIELD

The present implementations relate generally to mechanical systems, and more particularly to systems and methods for parallel path variators.

### BACKGROUND

Drive systems may be used in various technologies and machinery, to provide rotational or driving forces. Some drive systems may drive (e.g., provide rotational or driving forces) at a fixed drive speed, while other drive systems may drive at a variable drive speed.

For example, U.S. Pat. No. 4,514,991A describes a system and method for a variable speed drive motor system. The motor system is particularly suitable for use as a drive system for a centrifugal compressor in a refrigeration system. The motor system includes an AC auxiliary motor/generator with inverter control. The motor/generator is interconnected through a transmission system to a main motor to drive an output drive shaft at varying speeds. The interconnecting transmission system is an epicyclic gear system.

### SUMMARY

A first aspect provided herein relates to a system. The system can include a drive system and a compressor configured to be driven at a variable speed by the drive system. The drive system can include a gearbox including a first gear driven by a first input shaft, a second gear driven by a second input shaft, and a third gear driven by the first gear and the second gear. The third gear can drive an output shaft operatively coupled to the compressor. The drive system can include a first motor configured to operate at a constant drive speed, and the first motor can be operatively coupled to the first input shaft. The drive system can include a second motor configured to operate at a variable drive speed via a variable frequency drive, and the second motor can be operatively coupled to the second input shaft.

A second aspect provided herein relates to drive system. The drive system can include a gearbox including a first gear driven by a first input shaft, a second gear driven by a second input shaft, and a third gear driven by the first gear and the second gear. The third gear can drive an output shaft operatively coupled to an output element. The drive system can include a first motor configured to operate at a constant drive speed, and the first motor can be operatively coupled to the first input shaft. The drive system can include a second motor configured to operate at a variable drive speed via a variable frequency drive, and the second motor can be operatively coupled to the second input shaft.

A third aspect provided herein relates to a method of operating a drive system. The method can include driving a first input shaft with a first motor at a constant drive speed, and the first input shaft can be operatively coupled to a first gear in a gearbox. The method can include driving a second input shaft with a second motor at a variable drive speed, and the second input shaft can be operatively coupled to a second gear in the gearbox. The method can include the gearbox combining rotational forces of the first gear and the second gear to drive a third gear in the gearbox, and the third gear can be operatively coupled to an output shaft. The method can include driving a compressor with the output shaft at a variable speed.

### BRIEF DESCRIPTION OF THE DRAWINGS

These and other aspects and features of the present implementations will become apparent to those ordinarily skilled in the art upon review of the following description of specific implementations in conjunction with the accompanying figures.

FIG. 1 is a block diagram of a system for parallel path variable drive speed, in accordance with present implementations.

FIG. 2 is a block diagram of another system for parallel path variable drive speed, in accordance with present implementations.

FIG. 3 is a block diagram of yet another system for parallel path variable drive speed, in accordance with present implementations.

FIG. 4 is a block diagram of yet another system for parallel path variable drive speed, in accordance with present implementations.

FIG. 5 is a flowchart showing a method of driving a machine using a variable drive speed system, in accordance with present implementations.

### DETAILED DESCRIPTION

Before turning to the figures, which illustrate certain embodiments in detail, it should be understood that the present disclosure is not limited to the details or methodology set forth in the description or illustrated in the figures. It should also be understood that the terminology used herein is for the purpose of description only and should not be regarded as limiting.

Referring generally to the FIGURES, systems and methods described herein may be configured, designed, or otherwise arranged to implement a drive system including two motors and a gearbox to drive rotating machinery. In some implementations, a first motor of the two motors may operate at a constant drive speed and a second motor of the two motors may operate at a variable drive speed. The gearbox may combine rotational forces of the two motor motors and drive a compressor at variable speeds, as further described herein.

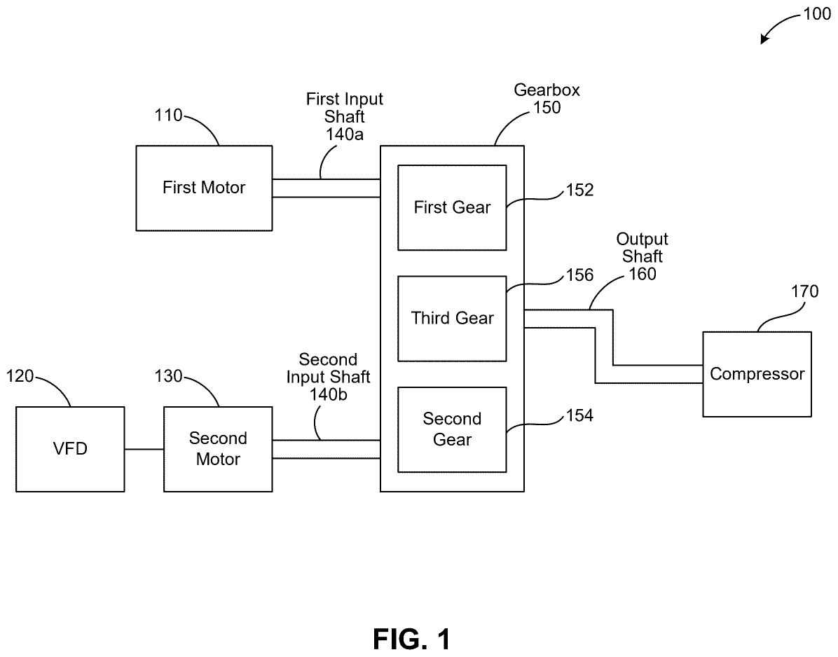

FIG. 1 is a block diagram of a system 100. As shown on FIG. 1, the system 100 can include a drive system with a first motor 110, a variable frequency drive (VFD) 120, a second motor 130, a first input shaft 140a, a second input shaft 140b, a gearbox 150, and an output shaft 160. The gearbox 150 can include a first gear 152, a second gear 154, and a third gear 156. The system 100 can further include a compressor 170 driven by the drive system.

As shown on FIG. 1, the first motor 110 can be operatively connected to or coupled with the gearbox 150 by the first input shaft 140a. In some embodiments, the first motor 110 may be coupled with the first gear 152. Similar, the second motor 130 can be operatively connected or coupled with the gearbox 150 by the second input shaft 140b. In some embodiments, the second motor 130 can be coupled with the second gear 154. That is, the first motor 110 can provide rotational force to the gearbox 150 via the first input shaft 140a and the first gear 152, the second motor 130 can provide rotational force to the gearbox 150 via the second input shaft 140b and the second gear 154. The gearbox 150 can be configured to combine these rotational forces using the third gear 156 meshing with the first gear 152 and/or second gear 154. The third gear 156 can be coupled to the output shaft 160, which can rotate at a variable speed and be coupled with the compressor 170 to cause the compressor 170 to rotate at a variable speed.

Generally, the first motor 110 can include any device configured to drive an input shaft (e.g., first input shaft 140a). In some examples, the first motor 110 could include various types of motors such as induction motors, synchronous motors, or other devices capable of driving the first input shaft 140a. In some examples, the first motor 110 may be configured to operate at a constant drive speed. That is, the first motor 110 can maintain a consistent rotational speed under varying load conditions (e.g., with a motor controller (not depicted on FIG. 1) transmitting a control signal to the first motor 110, or otherwise). A “constant speed” can generally refer to a rotational speed that remains unchanged or substantially unchanged during operation of the system 100 despite variations in load or input conditions. The first motor 110 can include an output (e.g., output shaft, coupling, etc.) which operatively connects the first motor 110 to the first input shaft 140a.

Still referring to FIG. 1, like the first motor 110, the second motor 130 can include any system, apparatus, or device (configured to drive an input shaft (e.g., second input shaft 140b). In some examples, the second motor 130 may be configured to operate at a variable drive speed. That is, the second motor 130 can be driven by the VFD 120, which adjusts the frequency of the electrical power supplied to the second motor 130, to control the rotational speed of the second motor 130. In other words, the VFD 120 can be configured to generate a signal which controls (e.g., modifies, configures, changes) the rotational speed of the second motor 130. The VFD 120 can include various types of VFD systems, such as but not limited to pulse-width modulation (PWM) VFDs or voltage source inverters (VSI). Generally, the VFD 120 can be any system configured to cause the second motor 130 to drive an input shaft at a variable speed and to regenerate power back to a source. A “variable speed” can generally refer to a rotational speed that can be adjusted or varied during operation of the system 100 (e.g., drive system) based on control inputs and/or changes in operating conditions (e.g., signaled or otherwise controlled by the VFD 120). The second motor 130 can include an output (e.g., output shaft, coupling, etc.) which operatively connects the second motor 130 to the second input shaft 140b.

In some embodiments, the VFD 120 may include an active rectifier. For example, the VFD 120 may include an AC input rectification section, a DC link with filtering, and an inverter. In some examples, the AC input rectification section can convert AC power to DC power and supply the DC power to the DC link. In some examples, the DC link can store and filter the DC power before providing the power to the inverter, which adjusts the frequency and voltage to drive the second motor 130 at variable speeds. Generally, in contrast with one-directional or passive rectifiers, the active rectifier of the VFD 120 may be bi-directional and configured to both supply and extract power from the DC link, and to further transmit the power to one or more components of FIG. 1 and/or another network. That is, the active rectifier of the VFD 120 may enable the second motor 130 to function as a generator when adjusting (e.g., slowing down) the rotational speed of the first motor 110. For example, when acting as a generator, the active rectifier of the VFD 120 can capture excess energy generated during deceleration and return the excess energy to a power source, motor, or other component of FIG. 1. Generally, the active rectifier of the VFD 120 may reduce losses, improve system efficiency, and/or prevent overvoltage conditions that may be associated with one-directional or passive rectifiers.

In some implementations, the first motor 110 can be referred to as a large motor relative to the second motor 130, and the second motor 130 can be referred to as a small motor relative to the first motor 110. That is, the term “large” can refer to the first motor 110 requiring more power input (e.g., but providing higher speeds or a higher power rotational output) relative to the second motor 130, and the term “small” can refer to the second motor 130 requiring less power input (e.g., but providing lower speeds or a lower power rotational output, such as around ⅓ of the large motor) relative to the first motor 110.

Generally, implementations of the system 100 including a large first motor 110 and small second motor 130 may provide improvements in cost or operation as compared to other variable drive systems. For example, some variable drive systems for driving a compressor may use a single motor and VFD to control and vary the speed of a compressor. To provide adequate output power, a large motor may be selected for the single motor, and to provide a variable output drive, a large VFD may be selected to vary the speed of the large single motor. However, large VFDs configured to operate large motors are generally expensive or costly. In contrast, some embodiments of the system 100 can include a larger motor 110 without a VFD and operating at a constant speed, while the smaller motor 130 includes VFD 120 to vary the speed of the smaller motor 130. Further, rotational outputs from both the larger motor 110 and smaller motor 130 may be input into the gearbox 150 to provide an adequately-powered and variable rotational output via the output shaft 160 to rotate the compressor 170.

Still referring to FIG. 1, the gearbox 150 can include any system, apparatus, or device configured to combine rotational forces and provide an output to the compressor 170. In some embodiments, the gearbox 150 can include a planetary gearbox (e.g., including a ring gear, sun gear, and carrier gear). For example, the first gear 152 can be or include a ring gear, the second gear 154 can be or include a sun gear, and the third gear 156 can be or include a carrier gear.

As used herein, a ring gear generally refers to a gear with teeth on an inner circumference that surrounds other gears within a planetary gearbox. In the context of the gearbox 150, the first gear 152 can be a ring gear that encircles the other gears of the gearbox 150 and meshes with the sun gear (second gear 154). A sun gear generally refers to an interior (or central) gear around which other gears in a planetary gearbox rotate. In the gearbox 150, the second gear 154 can be a sun gear that is positioned within the gearbox 150 (e.g., centrally) and is configured to engage with the ring gear (first gear 152). A carrier gear, sometimes referred to as a planet carrier, typically serves as a support structure that holds the planet gears and transmits their combined rotational forces. In the context of the gearbox 150, the third gear 156 can be a carrier gear that supports and holds the sun gear 154 and transmits the rotational forces from both the sun gear 154 and the ring gear 152 to the output shaft 160. That is, the third gear 156 provides combined forces from the sun gear 154 and the ring gear 152 to drive the output shaft 160, which in turn drives the compressor 170.

In some implementations, the first gear 152, second gear 154, and third gear 156 can generally refer to elements configured to transmit rotational force within the gearbox 150. For example, the first gear 152, second gear 154, and/or third gear 156 can include various types of gears (e.g., helical, spur, or bevel gears) or other elements configured to interlock or otherwise mesh together (e.g., through aligned teeth) to transmit rotational force within the gearbox 150. In some embodiments, the gearbox 150 can include one or more planet gears between the ring gear (e.g., first gear 152) and sun gear (e.g., second gear 154).

Generally, the input shafts 140a, 140b, and output shaft 160 can include any components configured to transmit rotational force within a mechanical system. For example, one or more of the input shafts 140a, 140b, and/or output shaft 160 can include a cylindrical body. In some embodiments, the input shafts 140a, 140b, and/or output shaft 160 can be solid. In some embodiments, the input shafts 140a, 140b, and/or output shaft 160 can be hollow. Further, the input shafts 140a, 140b, and/or output shaft 160 can be fabricated from various types of materials, such as steel or other alloys. In some embodiments, the input shafts 140a, 140b, and/or output shaft 160 can include various components and/or features (e.g., splines or keyways to provide secure coupling with other components, such as first motor 110 and/or second motor 130). In some embodiments, the input shafts 140a, 140b may be coupled with motor outputs (e.g., output shafts of the first motor 110, second motor 130) such that the first motor 110 and second motor 130 provide rotational motion and/or force to the input shafts 140a, 140b via the output shafts.

In some implementations, the compressor 170 can be a fluid compressor used in various compression applications. For example, the compressor 170 can be or include an industrial or commercial compressor which compresses fluids for industrial or commercial purposes. In some embodiments, the compressor 170 can include various types of compressors, such as reciprocating compressors, rotary screw compressors, or centrifugal compressors, configured for various applications depending on the type of fluid being compressed (e.g., gaseous compressors, liquid compressors), the required pressure, and the operational environment. For example, the compressor 170 can be used in contexts such as refrigeration, HVAC systems, or natural gas processing, among others. In some implementations, the compressor 170 generally can be or include to an output element powered by a rotational input. Additionally, while described as providing a variable drive system for a compressor, in various embodiments, the drive system 100 may be used in other contexts which may use or leverage variable speed rotational driving.

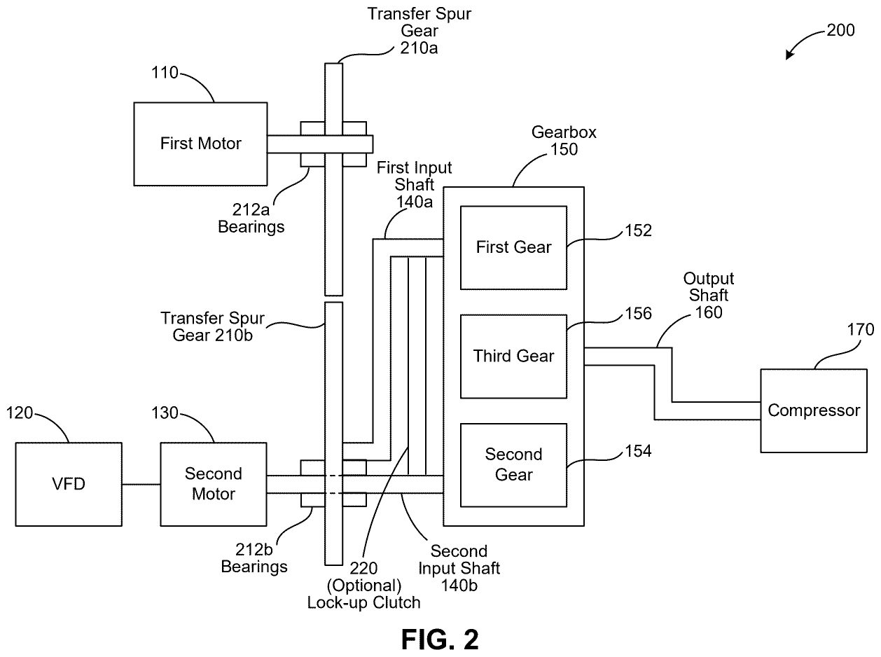

FIG. 2 is a block diagram of a system 200. As shown on FIG. 2, the system 200 can include first motor 110, VFD 120, second motor 130, first input shaft 140a, second input shaft 140b, gearbox 150, output shaft 160, and compressor 170. The system 200 can also include a transfer spur gear 210a, a transfer spur gear 210b, and a lock-up clutch 220. The transfer spur gear 210a can include bearings 212a, and the transfer spur gear 210b can include bearings 212b. Generally, the lock-up clutch 220 can be an optional element included in some embodiments of the system 200 and omitted in other embodiments of the system 200. In some implementations, the system 200 of FIG. 2 can include similar features/and or functionality as described regarding the system 100 of FIG. 1.

In some implementations, the first motor 110 can be operatively coupled to the first input shaft 140a (e.g., via an output shaft of the first motor 110), and the first input shaft 140a can be operatively coupled to the transfer spur gear 210a. Further, the second motor 130 can be operatively coupled to the second input shaft 140b (e.g., via an output shaft of the second motor 130). That is, the transfer spur gear 210a and transfer spur gear 210b can be a transfer gear set including a first transfer gear (e.g., transfer spur gear 210a) and second transfer gear (e.g., transfer spur gear 210b). In some embodiments, the output shaft of the second motor 130 or the second input shaft 140b can pass through the second transfer gear (transfer spur gear 210b) of the transfer gear set. The first input shaft 140a can be rotated by the interaction between the first transfer gear (transfer spur gear 210a) and the second transfer gear (transfer spur gear 210b), where the output shaft of the first motor 110 (e.g., output shaft, coupling, etc.) is configured to rotate the first input shaft 140a which rotates first transfer gear 210a and causes the first transfer gear 210a to rotate the second transfer gear 210b.

As described above, the first motor 110 can drive the first input shaft 140a which rotates the transfer spur gear 210a, the second motor 130 can drive the second input shaft 140b which rotates the transfer spur gear 210b, and the transfer spur gear 210a and transfer spur gear 210b can mesh (e.g., via teeth) or otherwise interlock such that rotation of one gear of transfer spur gear set (e.g., transfer spur gear 210a) causes another gear of the transfer gear set (e.g., transfer spur gear 210b) to rotate. Further, the first input shaft 140a can include a portion that is operatively coupled to the transfer spur gear 210b and to the gearbox 150 (e.g., via first gear 152). An output shaft of the second motor 130 (e.g., output shaft, coupling, etc.) can be coupled to the second input shaft 140b, which can be coupled with the gearbox 150 (e.g., via second gear 154). That is, the rotation of the transfer spur gear 210b can cause the first input shaft 140a to rotate or drive the first gear 152, and the rotation of the second input shaft 140b via the second motor 130 can rotate or drive the second gear 154.

As described above regarding FIG. 1, the gearbox 150 can combine the rotation of the first gear 152 and second gear 154 to rotate the third gear 156, which can rotate the output shaft 160 at a variable speed to power to the compressor 170. The lock-up clutch 220, when engaged, can cause the first gear 152 and the second gear 154 to rotate together according to one of the constant drive speed of the first motor 110 or the variable drive speed of the second motor 130. In some examples, the lock-up clutch 220 can be further configured to prevent the rotation of the transfer spur gears 210a-210b or gears of the gearbox 150 (e.g., preventing rotation of the output shaft 160).

Still referring to FIG. 2, a transfer spur gear set or transfer gear set can broadly refer to a combination of gears that transmit rotational forces from one component to another. That is, the transfer spur gear 210a and transfer spur gear 210b can be configured to rotate each other. Specifically, the output shaft of the first motor 110 is configured to rotate the first transfer gear 210a, which rotates the second transfer gear 210b, thereby rotating the first input shaft 140a. The meshing of the transfer spur gears 210a and 210b allows for the transfer and combination of rotational forces, which are transmitted to the compressor 170 through the gearbox 150. In some embodiments, an output shaft of the second motor 130 (e.g., motor output shaft, etc.) operatively connects with the second input shaft 140b, and the output shaft of the second motor 130 or the second input shaft 140b may pass through the transfer spur gear 210b (e.g., second transfer gear of the transfer gear set).

Generally, the bearings 212a and bearings 212b can include any components configured to support rotating elements and/or reduce friction. In some implementations, the bearings 212a can be positioned between the transfer spur gear 210a and the first input shaft 140a and/or output shaft of the first motor 110. Further, the bearings 212b can be positioned between the transfer spur gear 210b and the second input shaft 140b and/or output shaft of the second motor 130. Additionally, various rotating systems within the system 200 other than the transfer spur gear 210a and/or transfer spur gear 210b (e.g., gearbox 150, output shaft 160, etc.) can include bearing systems not depicted in FIG. 2.

Still referring to FIG. 2, the lock-up clutch 220 can include any system or device configured to engage or disengage different rotating components within a planetary gear system or gearbox 150. As shown in FIG. 2, the lock-up clutch 220 can be operatively coupled to the output and/or input shafts coupled with the first motor 110 and/or the second motor 130. For example, the first input shaft 140a can include a portion operatively coupled to the first motor 110 (e.g., via a motor output shaft) and the transfer spur gear 210a, and another portion operatively coupled to the transfer spur gear 210b and the gearbox 150 (e.g., via the first gear 152). The lock-up clutch 220 can be operatively coupled to the portion of the first input shaft 140a that connects the gearbox 150 to the transfer spur gear 210b and to the second input shaft 140b and output shaft of the second motor 130.

In some implementations, engagement or activation of the lock-up clutch 220 can selectively couple or decouple the rotational forces from the first motor 110 and the second motor 130, thereby controlling the rotational output delivered to the gearbox 150 and further controlling the rotation of the output shaft 160 and/or the power output delivered to the compressor 170. For example, the lock-up clutch 220 can cause the first gear 152 and the second gear 154 to rotate together according to one of the constant drive speed of the first motor 110 or the variable drive speed of the second motor 130.

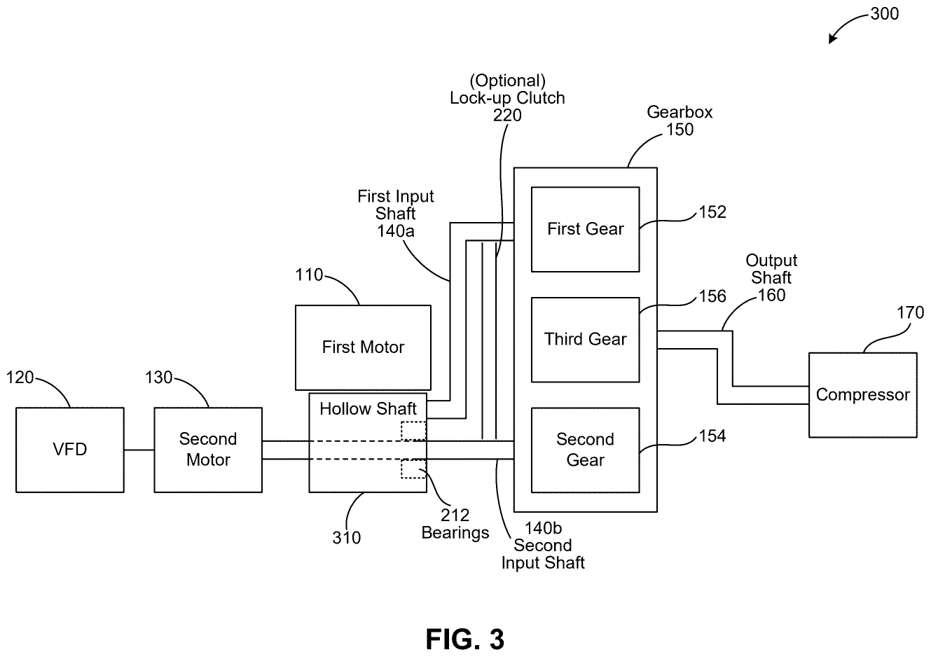

FIG. 3 is a block diagram of a system 300. As shown on FIG. 3, the system 300 can include first motor 110, VFD 120, second motor 130, first input shaft 140a, second input shaft 140b, gearbox 150, output shaft 160, compressor 170, bearings 212, and lock-up clutch 220. The system 300 can also include a hollow shaft 310. The gearbox 150 can include first gear 152, second gear 154, and third gear 156. Generally, the lock-up clutch 220 can be an optional element included in some embodiments of the system 300 and omitted in other embodiments of the system 300. In some implementations, the system 300 of FIG. 3 can include similar features/and or functionality as described regarding the system 100 of FIG. 1 and/or the system 200 of FIG. 2. In some embodiments, the system 300 can include a drive system.

In some implementations, the first motor 110 is operatively coupled to the hollow shaft 310. The hollow shaft 310 can be an output of the first motor 110 configured such that the second input shaft 140b, which is operatively coupled to the second motor 130, passes through the hollow shaft 310 and is also operatively coupled to the second gear 154 within the gearbox 150. The hollow shaft 310 can be operatively coupled to the first input shaft 140a and the first gear 152 within the gearbox 150. The hollow shaft 310 can be any component with similar features and/or functionality as the first input shaft 140a, the second input shaft 140b, or a motor output shaft, but can be hollow or include an area devoid of material. The hollow shaft 310 allows the second input shaft 140b to pass through, enabling the second motor 130 to drive the second gear 154. In some implementations, the bearings 212 can support and/or reduce friction caused by the rotation of the second input shaft 140b within the hollow shaft 310. As described above with regard to FIG. 1 and FIG. 2, the first input shaft 140a can be operatively coupled to the first gear 152, and the second input shaft 140b can be operatively coupled to the second gear 154. The gearbox 150 can combine the rotational forces from the first gear 152 and the second gear 154 into the third gear 156 to transmit the combined rotational force to the output shaft 160, which then rotates the compressor 170.

Still referring to FIG. 3, the lock-up clutch 220 can include any system or device configured to engage or disengage different rotating components within the gearbox 150. The lock-up clutch 220 can combine rotational forces from the first motor 110 and the second motor 130. That is, the lock-up clutch 220 can cause the first gear 152 and the second gear 154 to rotate together according to one of the constant drive speed of the first motor 110 or the variable drive speed of the second motor 130.

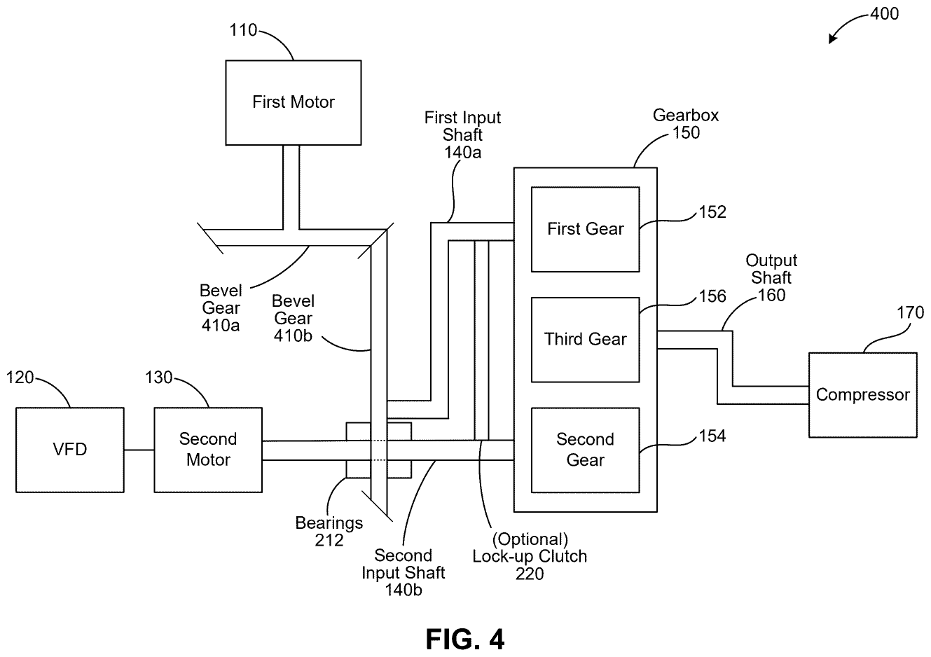

FIG. 4 is a block diagram of a system 400. As shown on FIG. 4, the system 400 can include first motor 110, VFD 120, second motor 130, first input shaft 140a, second input shaft 140b, gearbox 150 (including first gear 152, second gear 154, and third gear 156), output shaft 160, compressor 170, bearings 212, and lock-up clutch 220. The system 400 can also include a bevel gear set including bevel gear 410a and bevel gear 410b. In some implementations, the system 400 of FIG. 4 can include similar features/and or functionality as described regarding the system 100 of FIG. 1, the system 200 of FIG. 2, and/or the system 300 of FIG. 3. In some embodiments, the system 400 can include a drive system.

In some implementations, the first motor 110 is operatively coupled with bevel gear 410a (e.g., via an output shaft of the first motor 110). The bevel gear 410a may be configured to communicably couple with, rotate with, mesh with, or otherwise connect with the bevel hear 410b such that the bevel gears 410a, 410b rotate together (e.g., rotation of the bevel gear 410a causes the bevel gear 410b to rotate). The bevel gear 410b may be operatively coupled with the first input shaft 140a such that the first motor 110 rotates the first input shaft 140a via the interaction between the bevel gear 410a and the bevel gear 410b. Further, the first input shaft 140a may be operatively coupled with the first gear 152 such that rotational of the first input shaft 140a causes the first gear 152 to rotate. In some embodiments, an output shaft of the second motor 130 or the second input shaft 140b can pass through the bevel gear 410b of the bevel gear set and may be operatively coupled with the second gear 156 such that the second motor 130 rotates the second input shaft 140b, which causes the second gear 156 to rotate. That is, the first motor 110 can be operatively coupled to the first input shaft 140a via a bevel gear set (e.g., bevel gear 410a and bevel gear 410b), and an output shaft of the second motor 130 can operatively coupled to the second input shaft 140b passing through the bevel gear set (e.g., bevel gear 410a and bevel gear 410b).

As described above, the gearbox 150 may combine the rotational forces and/or motion of the first gear 152 and second gear 156 via the third gear 154, which may drive the output shaft 160 at variable speeds to power the compressor 170. Further, as described, the lock-up clutch 220 can combine rotational forces from the first motor 110 and the second motor 130 and cause the first gear 152 and the second gear 154 to rotate together according to one of the constant drive speed of the first motor 110 or the variable drive speed of the second motor 130.

### INDUSTRIAL APPLICABILITY

The disclosed embodiments may be applicable to any drive system. For example, the disclosed embodiments may be applicable to or applied to any drive system or other system used to provide a rotating output. For example, the disclosed embodiments may be applied to compressor, pumps, fans, turbines, conveyor systems, mixers, and other rotating systems used in industrial and commercial applications. Further, the disclosed embodiments may be applied to drive systems for gas compressor systems used in hydraulic fracturing systems, industrial refrigeration systems, and/or large-scale ventilation systems. As described herein, the disclosed embodiments can be or include a dual-motor system to provide control over a rotational output speed while reducing reliance on expensive or costly variable frequency drives (VFDs) typically used for large motors. For example, the first motor 110 can be larger than the second motor 130, driven at a constant speed, and operatively coupled to the gearbox 150 to provide a baseline rotational output. The second motor 130 can be controlled by a relatively small and cost-effective VFD 120, can operate at variable speeds, and can be operatively coupled to the gearbox 150 to provide a selective and/or variable rotational output. The gearbox 150 can combine the rotational outputs of the first motor 110 and the second motor 130 to drive the compressor 170 at varying speeds.

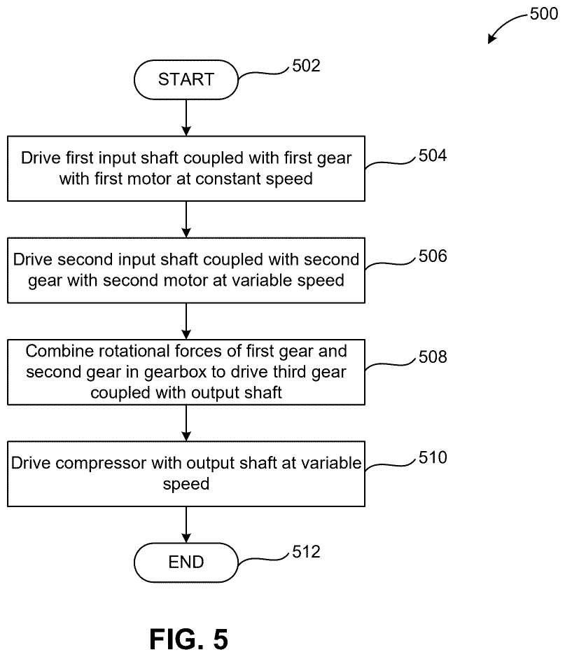

Referring now to FIG. 5, depicted is a flowchart showing an example method 500. The method 500 can be implemented on, or otherwise executed by the components, elements, or hardware described above with reference to FIG. 1, FIG. 2, FIG. 3, or FIG. 4. For example, the method 500 may be executed by the system 100 of FIG. 1. As a brief overview, at step 502, the method 500 can start. At step 504, the first motor 110 can drive first input shaft 140a coupled with first gear 152. At step 506, the second motor 130 can drive second input shaft 140b coupled with second gear 154. At step 508, the gearbox 150 can combine rotational forces of first gear 152 and second gear 154. At step 510, the output shaft 160 can drive the compressor 170. At step 512, the method 500 can end. In some embodiments, the method 500 can include a method of operating a drive system (e.g., system 100, system 200, system 300, system 400, etc.).

At step 502, the method 500 can start. In some embodiments, the method 500 can start in response to receiving a signal at step 502. The signal can include a control signal received (e.g., via an input/output (I/O) unit) by a drive system. For example, the method 500 can start at step 502 when a drive system (e.g., system 100, 200, etc.) receives a signal from an operator to drive an output element (e.g., compressor 170). That is, the method 500 can start responsive to receiving a control signal configured to cause a variation (e.g., increase, decrease, etc.) in an output speed of the drive system. In some embodiments, the method 500 can start in response to receiving or sensing a change in a drive speed of a drive system. Further, the method 500 can start in response to detecting or identifying a change in load or demand of a drive system (e.g., a load increase of compressor 170).

At step 504, the first motor 110 can drive the first input shaft 140a coupled with the first gear 152 of the gearbox 150 at a constant speed. In some embodiments, the first motor 110 can be operatively coupled to the first input shaft 140a via a transfer spur gear set, including a first transfer gear 210a and a second transfer gear 210b. In some embodiments, the first motor 110 can include a hollow motor shaft through which an output shaft of the second motor 130 (or second input shaft 140b) passes, to operatively couple the second motor 130 to the second gear 154. In some embodiments, the hollow motor shaft can be operatively coupled to the first input shaft 140a.

At step 506, the second motor 130 can drive the second input shaft 140b coupled with the second gear 154 of the gearbox 150 at a variable speed. In some embodiments, an output shaft of the second motor 130 can be operatively coupled to the second input shaft 140b, passing through the transfer gear set. In some embodiments, the transfer gear set can include a first transfer gear 210a and a second transfer gear 210b. An output shaft of the first motor 110 can be configured to rotate the first transfer gear 210a. The first transfer gear 210a can rotate the second transfer gear 210b, and the first input shaft 140a can be rotated by the second transfer gear 210b. In some embodiments, the output shaft of the second motor 130 can pass through the second transfer gear 210b of the transfer gear set.

At step 508, the gearbox 150 can combine the rotational forces of the first gear 152 and the second gear 154 to drive a third gear 156 in the gearbox 150. In some embodiments, the gearbox 150 can include a planetary gearbox. The first gear 152 can include a ring gear. The second gear 154 can include a sun gear. The third gear 156 can include a carrier gear. In some embodiments, the drive system can include a lock-up clutch 220 which causes the first gear 152 and the second gear 154 to rotate together according to one of the constant drive speed of the first motor 110 or the variable drive speed of the second motor 130. At step 510, the output shaft 160 can drive the compressor 170 at a combined variable speed.

At step 512, the method 500 can end. In some embodiments, the method 500 can end at step 512 when the drive system is turned off. For example, the method 500 can end when an operator turns off a machine (e.g., drive system, compressor, generator, vehicle, etc.) In some embodiments, the method 500 can loop back to step 502 and repeat steps 502-512. For example, the method 500 can return to step 502 to change or vary the speed of the drive system and/or output element (e.g., compressor 170).

By using the systems and methods described herein to drive a compressor at a variable speed, the drive system can include a two-motor configuration which can avoid expensive VFDs used to power large single motors. That is, variable speed can be achieved by modulating the speed of the small motor using a more cost-effective VFD, which may lower system costs. Additionally, the small motor can be used to rotate the larger motor during startup, which may reduce the starting current used by the large motor. The systems and methods described herein can further improve longevity or reliability of a drive system by distributing the operational load of the compressor across multiple motors. Overall, the systems and methods described herein provide improvements to drive systems and/or components driven by drive systems (e.g., compressors).

1. A system, comprising:
a compressor configured to be driven at a variable speed by a drive system; and
the drive system, comprising:
a gearbox including a first gear driven by a first input shaft, a second gear driven by a second input shaft, and a third gear driven by the first gear and the second gear, the third gear driving an output shaft operatively coupled to the compressor;
a first motor configured to operate at a constant drive speed, the first motor operatively coupled to the first input shaft;
a second motor configured to operate at a variable drive speed via a variable frequency drive, the second motor operatively coupled to the second input shaft; and
a lock-up clutch coupled to the first input shaft and the second input shaft, wherein the lock-up clutch causes the first gear and the second gear to rotate together according to one of the constant drive speed of the first motor or the variable drive speed of the second motor.

2. The system of claim 1, the gearbox comprising a planetary gearbox, the first gear comprising a ring gear, the second gear comprising a sun gear, and the third gear comprising a carrier gear.

3. The system of claim 1, wherein the first motor is operatively coupled to the first input shaft via a transfer gear set, and wherein an output shaft of the second motor is operatively coupled to the second input shaft passing through the transfer gear set.

4. The system of claim 3, wherein the transfer gear set comprises a first transfer gear and a second transfer gear, wherein an output shaft of the first motor is configured to rotate the first transfer gear which rotates the second transfer gear, and wherein the first input shaft is rotated by the second transfer gear.

5. The system of claim 4, wherein the output shaft of the second motor passes through the second transfer gear of the transfer gear set.

6. (canceled)

7. The system of claim 1, wherein the first motor comprises a hollow motor shaft through which an output shaft of the second motor passes through, to operatively couple the second motor to the second gear.

8. The system of claim 7, wherein the hollow motor shaft is operatively coupled to the first input shaft.

9. The system of claim 1, wherein the first motor is operatively coupled to the first input shaft via a bevel gear set, and wherein an output shaft of the second motor is operatively coupled to the second input shaft passing through the bevel gear set.

10. A drive system, comprising:
a gearbox including a first gear driven by a first input shaft, a second gear driven by a second input shaft, and a third gear driven by the first gear and the second gear, the third gear driving an output shaft operatively coupled to an output element;
a first motor configured to operate at a constant drive speed, the first motor operatively coupled to the first input shaft;
a second motor configured to operate at a variable drive speed via a variable frequency drive, the second motor operatively coupled to the second input shaft; and
a lock-up clutch coupled to the first input shaft and the second input shaft, wherein the lock-up clutch causes the first gear and the second gear to rotate together according to one of the constant drive speed of the first motor or the variable drive speed of the second motor.

11. The drive system of claim 10, the gearbox comprising a planetary gearbox, the first gear comprising a ring gear, the second gear comprising a sun gear, and the third gear comprising a carrier gear.

12. The drive system of claim 10, wherein the first motor is operatively coupled to the first input shaft via a transfer gear set, and wherein an output shaft of the second motor is operatively coupled to the second input shaft passing through the transfer gear set.

13. The drive system of claim 12, wherein the transfer gear set comprises a first transfer gear and a second transfer gear, wherein an output shaft of the first motor is configured to rotate the first transfer gear which rotates the second transfer gear, wherein the first input shaft is rotated by the second transfer gear.

14. The drive system of claim 13, wherein the output shaft of the second motor passes through the second transfer gear of the transfer gear set.

15. (canceled)

16. The drive system of claim 10, wherein the first motor comprises a hollow motor shaft through which an output shaft of the second motor passes through, to operatively couple the second motor to the second gear.

17. The drive system of claim 16, wherein the hollow motor shaft is operatively coupled to the first input shaft.

18. The drive system of claim 10, wherein the first motor is operatively coupled to the first input shaft via a bevel gear set, and wherein an output shaft of the second motor is operatively coupled to the second input shaft passing through the bevel gear set.

19. A method of operating a drive system, the method comprising:
driving a first input shaft with a first motor at a constant drive speed, the first input shaft being operatively coupled to a first gear in a gearbox;
driving a second input shaft with a second motor at a variable drive speed, the second input shaft being operatively coupled to a second gear in the gearbox, the gearbox combining rotational forces of the first gear and the second gear to drive a third gear in the gearbox, the third gear being operatively coupled to an output shaft; and
driving a compressor with the output shaft at a variable speed, wherein a lock-up clutch is coupled to the first input shaft and the second input shaft, and wherein the lock-up clutch causes the first gear and the second gear to rotate together according to one of the constant drive speed of the first motor or the variable drive speed of the second motor.

20. The method of claim 19, wherein the gearbox comprises a planetary gearbox, the first gear comprising a ring gear, the second gear comprising a sun gear, and the third gear comprising a carrier gear.
